(19) United States
(12) Patent Application Publication
(10) Pub. No.: US 2022/0350371 A1
(43) Pub. Date: Nov. 3, 2022

(54) DISPLAY DEVICE AND IMAGE FORMING APPARATUS

(71) Applicant: KYOCERA Document Solutions Inc., Osaka (JP)

(72) Inventor: Masato HIRABE, Osaka (JP)

(73) Assignee: KYOCERA Document Solutions Inc., Osaka (JP)

(21) Appl. No.: 17/624,224

(22) PCT Filed: Aug. 28, 2020
(86) PCT No.: PCT/JP2020/032506

§ 371 Date: Dec. 30, 2021

(30) Foreign Application Priority Data
Sep. 4, 2019 (JP) 2019-161549

(51) Int. Cl. G06F 1/16; G06F 3/04883; G06F 3/04817; G06F 3/041

(52) U.S. Cl. CPC G06F 1/1677; G06F 3/04883; G06F 1/1616; G06F 3/04817; G06F 3/0412; G06F 2203/04102; G06F 2203/04808

(57) ABSTRACT

When on a display device a closed state where the display device is folded is detected by an opening/closing detecting device, a controller allows at least one icon or button to be displayed on a screen of a display. When an open state where the display device is opened in a flat configuration is detected by the opening/closing detecting device, the controller changes the icon or button in shape or size on the screen of the display.

### TECHNICAL FIELD

The present invention relates to a foldable display device with a display and a touch panel and an image forming apparatus with the display device and particularly relates to a technique for display control according to opening/closing of the display device.

### BACKGROUND ART

A display device includes a display and a touch panel provided on the screen of the display. When an icon or a button displayed on the screen of the display is specified by a touch gesture, a point where the touch gesture has been made is detected by the touch panel and the specified icon or button is identified based on the point where the touch gesture has been made. Furthermore, recently, there have been display devices in which both of a display and a touch panel have flexibility to make the display devices themselves foldable.

An information processing device described in Patent Literature 1 includes a first housing and a second housing and is made foldable by a hinge (joint) connecting between the first housing and the second housing, wherein when the angle made by the first housing and the second housing is in a range of undisplayable angles, one of the first housing and the second housing is selected and the display portion of the selected housing is allowed to display.

### CITATION LIST

### Patent Literature

Patent Literature 1: JP-A-2018-31884

### SUMMARY OF INVENTION

### Technical Problem

When the above display device is in a folded state, the user views a half-region of the screen of the display located on one side of the screen. On the other hand, when the display device is in an open state, the user views the entire screen of the display. In view of this, there is provided a display device in which, when folded, icons or buttons are arranged and displayed only in one of half-regions of the screen of the display and, when the display device is opened, the icons or buttons are rearranged and displayed on the entire screen of the display.

However, when the icons or buttons having been displayed in a layout for arranging them only in the one half-region of the screen of the display are arranged and displayed on the entire screen of the display as they are, the icons or buttons are to be displayed in a wider area than before and, therefore, it is desirable that the user can easily recognize the icons or buttons in a state where they are displayed in the wider area.

In the case where, as described in Patent Literature 1, the angle made by the first housing and the second housing is in a range of undisplayable angles, allowing only the display portion of the selected one of the first housing and the second housing to display cannot realize the challenge that the user can easily recognize the icons or buttons in a state where they are displayed in the wider area.

The present invention has been made in view of the foregoing circumstances and has an object of enabling icons or buttons having been displayed only in a half-region of the screen of a display to be put into a display state suitable for a wider area covering the entire screen of the display to allow the user to easily recognize the icons or buttons.

### Solution to Problem

A display device according to an aspect of the present invention includes a display having flexibility to make the display foldable; a touch panel provided on a screen of the display and having flexibility to make the touch panel foldable; an openable and closable body that supports the display and the touch panel and is opened or folded together with the display and the touch panel when subjected to an opening or closing operation; an opening/closing detecting device that detects an open state where the openable and closable body is opened and a closed state where the openable and closable body is folded; and a controller that, upon detection of the open state by the opening/closing detecting device while allowing at least one icon or button to be displayed on the screen of the display in a state where the closed state is detected by the opening/closing detecting device, changes the icon or button in shape or size on the screen of the display.

An image forming apparatus according to another aspect of the present invention includes the above-described display device and an image forming device capable of forming an image on a recording paper sheet.

### Advantageous Effects of Invention

The present invention enables icons or buttons having been displayed only in a half-region of the screen of a display to be put into a display state suitable for a wider area covering the entire screen of the display to allow the user to easily recognize the icons or buttons.

### BRIEF DESCRIPTION OF DRAWINGS

FIG. 1 is a block diagram showing respective internal configurations of a display device and an image forming apparatus according to one embodiment of the present invention.

FIG. 2A is a perspective view showing a state where the display device according to the embodiment is folded in two.

FIG. 2B is a plan view showing a state where the display device according to the embodiment is opened into a flat configuration.

FIG. 3A is a view showing a state where icons are arranged and displayed in one of two half-regions of the screen of a display separated by a portion of the screen where the screen is folded in two.

FIG. 3B is a view showing a state where icons changed in shape are arranged and displayed over the entire screen of the display.

FIG. 3C is a view showing a state where icons changed in size are arranged and displayed over the entire screen of the display.

FIG. 4A is a view showing a state where icons are arranged and displayed in one of two half-regions of the screen of the display separated by the portion of the screen where the screen is folded in two.

FIG. 4B is a view showing a state where icons changed in shape are arranged and displayed over the entire screen of the display and other subordinate icons are displayed in an empty space.

FIG. 5 is a flowchart showing display control of icons on the screen of the display.

### DESCRIPTION OF EMBODIMENTS

Hereinafter, a description will be given of an embodiment of the present invention with reference to the drawings.

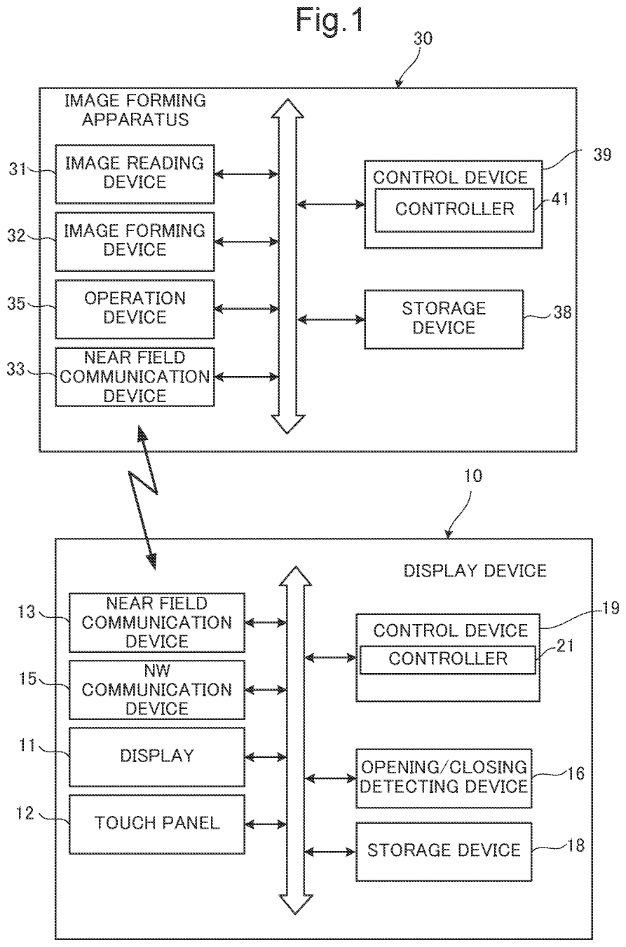

FIG. 1 is a block diagram showing respective internal configurations of a display device and an image forming apparatus according to one embodiment of the present invention.

An image forming apparatus 30 according to this embodiment includes an image reading device 31, an image forming device 32, an operation device 35, a near field communication device 33, a storage device 38, and a control device 39. These components are capable of sending and receiving data or signals via a bus to and from each other.

The image reading device 31 includes a scanner that optically reads an original document placed on an original glass plate, and generates image data representing the image of the original document.

The image forming device 32 includes: a photosensitive drum; a charging device that uniformly charges the surface of the photosensitive drum; an exposure device that exposes the surface of the photosensitive drum to light to form an electrostatic latent image on the surface of the photosensitive drum; a developing device that develops the electrostatic latent image on the surface of the photosensitive drum into a toner image; a transfer device that transfers the toner image (an image) on the surface of the photosensitive drum to a recording paper sheet; and so on, and forms the image represented by the image data on the recording paper sheet.

The near field communication device 33 is a communication device that performs data communication with the display device 10 through near field communication based on the Bluetooth Low Energy (BLE, where Bluetooth is a registered trademark).

The operation device 35 includes physical keys, including numeric keys, an Enter key, and a Start key.

The storage device 38 is a large storage device, such as an SSD (solid state drive) or an HDD (hard disk drive) and holds various types of application programs and various types of data.

The control device 39 is made up of a processor, a RAM (random access memory), a ROM (read only memory), and so on. The processor is, for example, a CPU (central processing unit), an ASIC (application specific integrated circuit), an MPU (micro processing unit) or the like. When a control program stored in the above ROM or the storage device 38 is executed by the above processor, the control device 39 functions as a controller 41.

The controller 41 performs the overall control of the image forming apparatus 30. The control device 39 is connected to the image reading device 31, the image forming device 32, the near field communication device 33, the operation device 35, the storage device 38, and so on. The controller 41 performs the operation control of these components and signal or data transfer to and from each of these components.

The controller 41 serves as a processor that executes various types of processing necessary for image formation by the image forming apparatus 30. The controller 41 accepts, based on an operation made on a physical key of the operation device 35, an operating instruction input by the user. The controller 41 also controls the communication operation of the near field communication device 33.

When, on the image forming apparatus 30 having the above configuration, for example, the user places an original document in the image reading device 31 and operates the Start key of the operation device 35, the controller 41 allows the image reading device 31 to read the image of the original document and allows the image forming device 32 to print the image on a recording paper sheet.

On the other hand, the display device 10 is, for example, a smartphone or a mobile device and includes a display 11, a touch panel 12, a near field communication device 13, a network communication device (NW communication device) 15, an opening/closing detecting device 16, a storage device 18, and a control device 19. These components are capable of sending and receiving data or signals via a bus to and from each other.

The display 11 is a known liquid crystal display (LCD), a known organic EL (organic light-emitting diode (OLED)) display or the like, having folding flexibility.

The touch panel 12 is a known touch panel having folding flexibility and is foldable. The touch panel 12 is disposed on the screen of the display 11, detects a touch on the touch panel 12 with a user's finger or the like, together with a point of the touch, and accepts an input of an instruction associated with the point of touch on the screen of the display 11. The touch panel 12 serves as an operation device through which a user's instruction is input by the user's gesture made toward the screen of the display 11.

The near field communication device 13 is a communication device that performs data communication with the image forming apparatus 30 through near field communication based on the Bluetooth Low Energy.

The network communication device (NW communication device) 15 is a communication interface including an unshown communication module, such as a LAN chip. The network communication device 15 is connected via a LAN or the Internet to an external terminal device and so on.

The storage device 18 is a RAM, a ROM or like storage device and holds various types of application programs and various types of data.

The control device 19 is made up of a processor, a RAM, a ROM, and so on. The processor is, for example, a CPU, an ASIC, an MPU or the like. When a control program stored in the above ROM or the storage device 18 is executed by the above processor, the control device 19 functions as a controller 21.

The control device 19 is connected to the display 11, the touch panel 12, the near field communication device 13, the network communication device 15, the opening/closing detecting device 16, the storage device 18, and so on. The controller 21 performs the operation control of these components and signal or data transfer to and from each of these components.

The controller 21 serves as a processor that executes various types of processing. The controller 21 also has the function of controlling the display operation of the display 11 and the function of the communication operations of the near field communication device 13 and the network communication device 15. Furthermore, the controller 21 identifies, based on an output detected by the touch panel 12, a touch gesture made on the screen of the display 11 and a location on the screen of the display 11 specified by the touch gesture.

When, on the display device 10 having the above configuration, for example, the user makes a double-tap gesture (a predetermined second tap gesture) on an icon on the screen of the display 11, the controller 21 identifies, based on an output detected by the touch panel 12, a location of the double-tap gesture and an icon being displayed at the location and executes processing previously associated with the identified icon.

Furthermore, the display device 10 performs data communication through the near field communication device 13 with the image forming apparatus 30. For example, the controller 21 reads from the storage device 18 an application for a graphical user interface (GUI) for doing remote control of the image forming apparatus 30, executes the application to allow the GUI to be displayed on the screen of the display 11, and detects a touch gesture on the GUI through the touch panel 12. Then, the controller 21 identifies, based on the touch gesture, an instruction for the image forming apparatus 30 input by the user and sends the identified instruction through the near field communication device 13 to the image forming apparatus 30. On the image forming apparatus 30, the near field communication device 33 receives the instruction and the controller 41 controls the image forming apparatus 30 according to the instruction. In a specific example, a print instruction is sent, together with an image, from the display device 10 to the image forming apparatus 30 and, on the image forming apparatus 30, the image forming device 32 records the image on a recording paper sheet under the control of the controller 41.

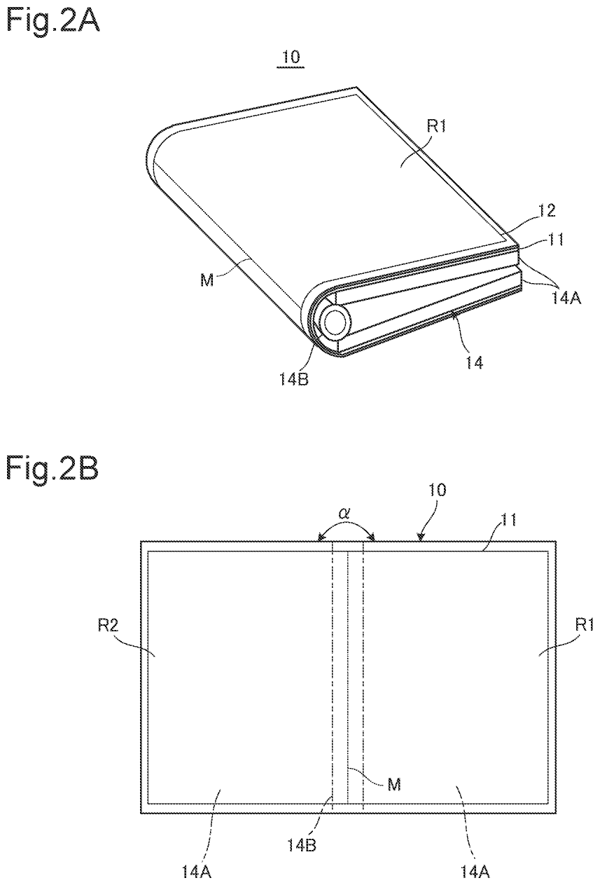

FIGS. 2A and 2B are perspective and plan views showing a state where the display device 10 is folded in two and a state where the display device 10 is opened into a flat configuration, respectively. As shown in FIG. 2A, the display device 10 includes the display 11 and an openable and closable body 14 supporting the touch panel 12. The openable and closable body 14 is opened and folded together with the display 11 and the touch panel 12 according to an opening operation and an closing operation, respectively. A detailed description will be given below of the openable and closable body 14. As shown in FIGS. 2A and 2B, the openable and closable body 14 is a mechanism including: a hinge 14B; and two thin housings 14A joined together by the hinge 14B. The openable and closable body 14 opens and closes each of the thin housings 14A by pivotally moving it around the hinge 14B. The thin housings 14A contain the near field communication device 13, the network communication device 15, the storage device 18, the control device 19, and so on. Furthermore, the display 11 and the touch panel 12 are overlaid on and attached to substantially the whole of the outer walls of thin housings 14A.

Since both the display 11 and the touch panel 12 have flexibility as described previously, the display device 10 is, with the opening/closing of the thin housings 14A, selectively put into a state where the display 11 and the touch panel 12 are folded in two or a flat state where the display 11 and touch panel 12 are opened to form a single flat configuration.

The opening/closing detecting device 16 shown in FIG. 1 is, for example, a rotational angle sensor provided on the hinge 14B, detects the opening/closing angle α between both the thin housings 14A, and outputs the detected opening/closing angle α to the controller 21.

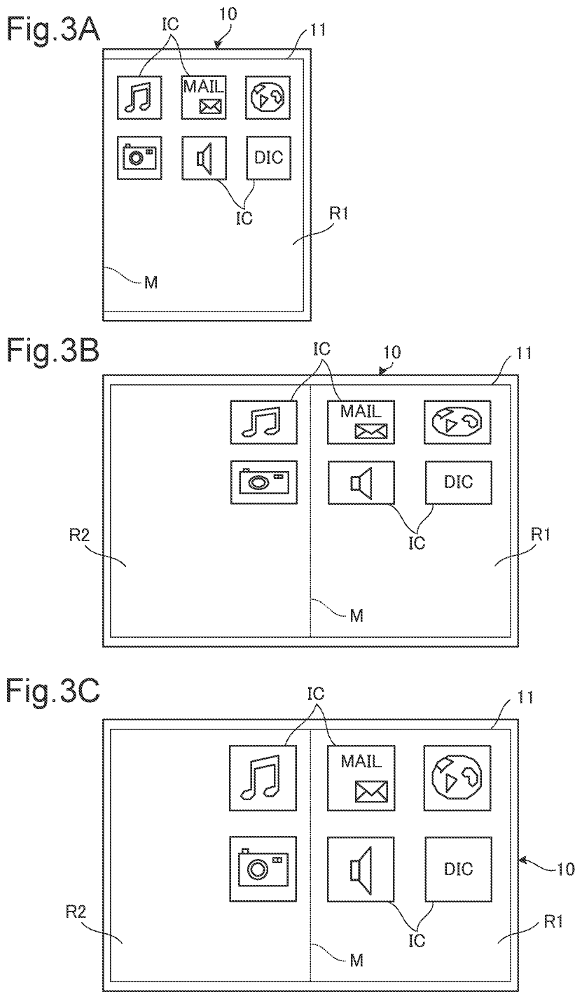

In doing so, the controller 21 compares the opening/closing angle α of the thin housings 14A detected by the opening/closing detecting device 16 with a preset and previously stored angle threshold D. When the opening/closing angle α is less than the angle threshold D, the controller 21 determines that the display 11 and the touch panel 12 are folded in two (determines that the openable and closable body 14 is in a closed state), and arranges and displays the icons in one of two half-regions of the screen of the display 11 separated by the portion of the screen where the screen is folded. For example, as shown in FIG. 3A, the icons IC are displayed in one half-region R1 of two half-regions of the screen of the display 11 separated by the portion M of the screen where the screen is folded, and no icon is displayed in the other half-region R2 of the screen. In this case, the user makes a touch gesture, such as a double-tap gesture, on any icon IC in the one half-region R1 while viewing the one half-region R1.

On the other hand, when the opening/closing angle α is equal to or greater than the angle threshold D, the controller 21 determines that the display 11 and the touch panel 12 are open in a flat configuration (determines that the openable and closable body 14 is in an open state), arranges and displays the icons over the entire screen of the display 11 (the entire screen of the display 11 having a single flat configuration formed when in the above flat state), and elongates the shapes of the icons in a direction perpendicular to the folded portion (a transverse direction) or increases the sizes of the icons. For example, the controller 21 arranges and displays the icons IC over the entire screen of the display 11 and elongates the shapes of the icons IC in a direction perpendicular to the folded portion M (a transverse direction) as shown in FIG. 3B or increases the sizes of the icons IC as shown in FIG. 3C. Therefore, when the user opens the display 11 and the touch panel 12 into a flat configuration, the icons having been displayed only in one half-region of the screen of the display are put into a display state suitable for a wider area covering the entire screen of the display 11, so that the user can easily recognize the icons.

Furthermore, some of the icons are given a hierarchical relationship composed of a superordinate icon and subordinate icons belonging to the superordinate icon and the storage device 18 previously stores these icons and their hierarchical structure. When an icon being displayed in one of both half-regions of the screen of the display 11 separated by the folded portion of the screen is specified by a single-tap gesture (a predetermined first tap gesture) while the controller 21 determines, based on an opening/closing angle α detected by the opening/closing detecting device 16, that the display 11 and the touch panel 12 are folded in two, the controller 21 identifies the icon specified by the single-tap gesture. Subsequently, when the controller 21 determines, based on an opening/closing angle α detected by the opening/closing detecting device 16, that the display 11 and the touch panel 12 are opened in a flat configuration, the controller 21 arranges and displays the icons over the entire screen of the display 11, elongates the shapes of the icons in the transverse direction or increases the sizes of the icons, searches, based on the icons stored in the storage device 18 and the respective hierarchical structures of the icons stored in the storage device 18, for other subordinate icons hierarchically lower than the icon specified by the above single-tap gesture, and allows the other subordinate icons retrieved from the search to be displayed in an empty space of the screen of the display 11.

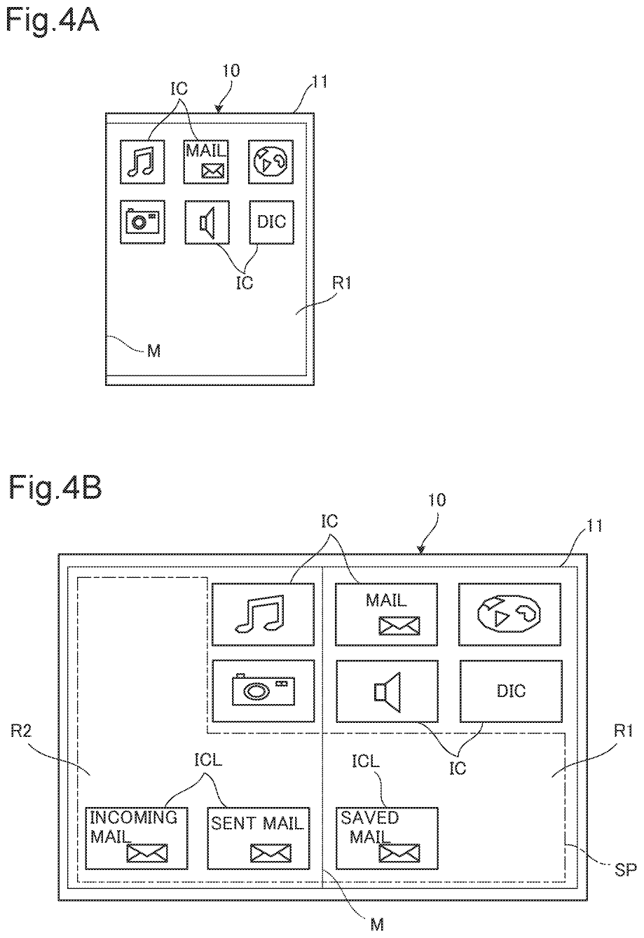

For example, when a Mail icon IC being displayed in one half-region R1 of the screen of the display 11 folded in two as shown in FIG. 4A is specified by a single-tap gesture and subsequently the display 11 and the touch panel 12 are opened in a flat configuration as shown in FIG. 4B, the controller 21 arranges and displays the icons IC over the entire screen of the display 11, elongates the shapes of the icons IC in the transverse direction, and additionally displays other subordinate icons ICL hierarchically lower than the specified Mail icon IC in an empty space SP of the screen of the display 11.

In doing so, when the controller 21 determines that the empty space SP is too narrow to display the other subordinate icons ICL, the controller 21 changes the locations of the superordinate icons IC on the screen of the display 11 to enlarge the empty space SP and then displays the other subordinate icons ICL in the empty space SP. Thus, the user can easily know the other subordinate icons ICL hierarchically lower than the specified Mail icon IC.

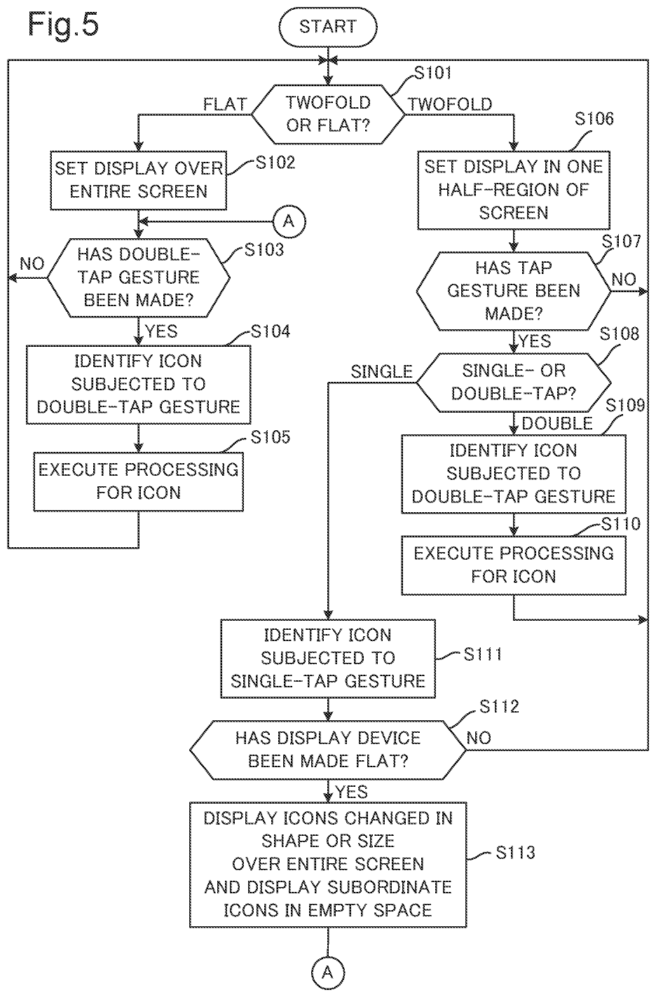

Next, a description will be given of the display control of icons on the screen of the display 11 described as above, with reference to the flowchart shown in FIG. 5.

First, the controller 21 compares the opening/closing angle α of the thin housings 14A detected by the opening/closing detecting device 16 with the preset angle threshold D to determine whether the display 11 and the touch panel 12 are folded in two or opened in a flat configuration (S101).

For example, when the user has opened the display 11 and the touch panel 12 in a flat configuration, the opening/closing angle α of the thin housings 14A detected by the opening/closing detecting device 16 is equal to or greater than the angle threshold D. Therefore, the controller 21 determines that the display 11 and the touch panel 12 are opened in a flat configuration (S101 “FLAT”), sets the entire screen of the display 11 as an icon display region, elongates the shapes of the icons in the transverse direction or increases the sizes of the icons, and arranges and displays the icons over the entire screen (S102).

In this state, the controller 21 waits for a double-tap gesture while determining, based on an output detected by the touch panel 12, whether or not the double-tap gesture has been made (S103).

For example, when a certain period of time has passed from the start time of waiting for a double-tap gesture before the controller 21 determines that a double-tap gesture has been made (S103 “No”), the controller 21 returns the processing to S101.

When the user makes a double-tap gesture on any icon on the screen of the display 11 before the certain period of time passes from the start time of waiting for a double-tap gesture in S103, the controller 21 determines through the touch panel 12 that the double-tap gesture has been made (S103 “Yes”), identifies the icon on the screen of the display 11 on which the double-tap gesture has been made (S104), executes processing previously associated with the identified icon (S105), and returns the processing to S101. As long as the display 11 and the touch panel 12 are kept in a flat, open state (S101 “FLAT”), the processing in S102 to S105 is repeated.

On the other hand, when the user has folded the display 11 and the touch panel 12 in two, the opening/closing angle α of the thin housings 14A detected by the opening/closing detecting device 16 is less than the angle threshold D. Therefore, the controller 21 determines that the display 11 and the touch panel 12 are folded in two (S101 “TWOFOLD”), sets as an icon display region one of half-regions of the screen of the display 11 separated by the portion of the screen where the screen is folded, and arranges and displays the icons in the one half-region (S106).

In this state, the controller 21 waits for a single- or double-tap gesture while determining, based on an output detected by the touch panel 12, whether or not a single- or double-tap gesture has been made in the one half-region of the screen (S107).

For example, when a certain period of time has passed from the start time of waiting for a single- or double-tap gesture in S107 before the controller 21 determines that a single- or double-tap gesture has been made in the one-half region of the screen (S107 “No”), the controller 21 returns the processing to S101.

On the other hand, when the user makes a double-tap gesture on any icon on the screen of the display 11 before the certain period of time passes from the start time of waiting for a single- or double-tap gesture in S107, the controller 21 determines through the touch panel 12 that a single- or double-tap gesture has been made (S107 “Yes”, S108). When determining that the tap gesture is a double-tap gesture (S108 “DOUBLE”), the controller 21 identifies the icon on the screen of the display 11 on which the double-tap gesture has been made (S109) and executes processing previously associated with the identified icon (S110). Thereafter, the processing goes back to S101.

The above processing in S106 to S110 is repeated, as long as the display 11 and the touch panel 12 are kept in a twofold state (S101 “TWOFOLD”) and the controller 21 determines that a tap gesture made on the screen is a double-tap gesture (S108 “DOUBLE”).

Alternatively, when the user makes a single-tap gesture on any icon on the screen of the display 11 before the certain period of time passes from the start time of waiting for a tap gesture in S107, the controller 21 determines through the touch panel 12 that the tap gesture made on the screen is a single-tap gesture (S107 “Yes”, S108 “SINGLE”), identifies the icon on the screen of the display 11 on which the single-tap gesture has been made and allows the identified icon to be memorized (S111). Subsequently, the controller 21 continues to execute the processing for determining, based on an opening/closing angle α of the thin housing 14A detected by the opening/closing detecting device 16, whether or not the display 11 and the touch panel 12 have been opened in a flat configuration (S112), while waiting for the display 11 and the touch panel 12 to be opened in a flat configuration.

For example, when the display 11 and the touch panel 12 are not opened in a flat configuration before a certain period of time passes from the start time of waiting for them to be opened in a flat configuration in S112 (S112 “No”), the controller 21 cancels the single-tap gesture. The processing goes back to S101.

On the other hand, when, before the certain period of time passes from the start time of waiting for the display 11 and the touch panel 12 to be opened in a flat configuration in S112, the controller 21 determines that the display 11 and the touch panel 12 have been opened in a flat configuration by the user (S112 “Yes”), the controller 21 searches, based on the icons stored in the storage device 18 and the respective hierarchical structures of the icons stored in the storage device 18, for other subordinate icons hierarchically lower than the identified icon, and allows the other subordinate icons identified by the search to be displayed in an empty space of the screen of the display 11 (S113).

In this state, the controller 21 waits for a double-tap gesture while continuing to execute the processing for determining, based on an output detected by the touch panel 12, whether or not a double-tap gesture has been made (S103). Then, when the certain period of time has passed from the start time of waiting for a double-tap gesture before the controller 21 determines that a double-tap gesture has been made (S103 “No”), the controller 21 returns the processing to S101. On the other hand, when the user makes a double-tap gesture on any icon on the screen of the display 11 before the certain period of time passes from the start time of waiting for a double-tap gesture in S103, and the controller 21 determines through the touch panel 12 that the double-tap gesture has been made (S103 “Yes”), the controller 21 identifies the icon on the screen of the display 11 on which the double-tap gesture has been made (S104), and executes processing previously associated with the identified icon (S105). Then, the processing goes back to S101.

From here forward, as long as the display 11 and the touch panel 12 are kept in a flat, open state (S101 “FLAT”), the other subordinate icons are continued to be displayed on the screen of the display 11 and the processing in S102 to S105 is repeated.

When the user folds the display 11 and the touch panel 12 in two, the controller 21 determines that the display 11 and the touch panel 12 are folded in two (S101 “TWOFOLD”), renders the other subordinate icons undisplayed on the screen of the display 11, sets as an icon display region one of the half-regions of the screen of the display 11 separated by the portion of the screen where the screen is folded in two, and arranges and displays the icons in the one half-region (S106).

Furthermore, when the user opens the display 11 and the touch panel 12 in a flat configuration again (“No” in S107), the controller 21 determines that the display 11 and the touch panel 12 are opened in a flat configuration (S101 “FLAT”), sets the entire screen of the display 11 as an icon display region, elongates the shapes of the icons in the transverse direction or increases the sizes of the icons, and arranges and displays the icons over the entire screen (S102).

As thus far described, when the display 11 and the touch panel 12 are opened in a flat configuration, the controller 21 sets the entire screen of the display 11 as an icon display region, elongates the shapes of the icons in the transverse direction or increases the sizes of the icons, and arranges and displays the icons over the entire screen. On the other hand, when the display 11 and the touch panel 12 are folded in two, the controller 21 sets as an icon display region one of half-regions of the screen of the display 11 separated by the portion of the screen where the screen is folded, and arranges and displays the icons in their original shapes and sizes in the one half-region. Then, when a single-tap gesture is made on one of the icons displayed on the one half-region and, subsequently, the display 11 and the touch panel 12 are opened in a flat configuration, the controller 21 searches for other subordinate icons hierarchically lower than the specified icon and allows the other subordinate icons retrieved from the search to be displayed in an empty space of the screen of the display 11. Thus, an easy-to-use display device can be provided.

In the above embodiment, when on the display device 10 the opening/closing detecting device 16 detects an open state (a single flat configuration) having changed from a closed state (a twofold state), the controller 21 identifies an icon having been operated through the touch panel 12 on the screen of the display 11 when the display device 10 was in a closed state, and allows other subordinate icons hierarchically lower than the operated icon to be displayed in an empty space of the screen of the display 11. However, instead of the other subordinate icons, information previously stored in association with the operated icon (for example, a manner of operation for editing the icon) may be displayed in an empty space of the screen of the display 11 being in an open state.

Although in the above embodiment the controller 21 of the display device 10 handles icons as objects to be displayed on the display 11, the controller 21 may handle buttons instead of or in addition to the icons as objects to be displayed and may perform the above-described display control in the same manner as when the icons are objects to be displayed.

Although in the above embodiment icons are displayed on the screen of the display 11 of the display device 10, a GUI for doing the above-described remote control of the image forming apparatus 30 may be displayed on the screen of the display 11. In this case, the controller 21 identifies, based on a touch gesture on the GUI, an instruction for the image forming apparatus 30 input by the user and sends the identified instruction through the near field communication device 13 to the image forming apparatus 30. On the image forming apparatus 30, the near field communication device 33 receives the instruction and the controller 41 controls the image forming apparatus 30 according to the instruction. Also in this case, like the processing described with reference to FIG. 5, when the display 11 and the touch panel 12 are opened in a flat configuration, the controller 21 elongates the shapes of operation buttons of the GUI in the transverse direction or increases the sizes of the operation buttons, and arranges and displays the operation buttons over the entire screen of the display 11. On the other hand, when the display 11 and the touch panel 12 are folded in two, the controller 21 arranges and displays the operation buttons of the GUI in their original shapes and sizes in one of the half-regions of the screen of the display 11 separated by the portion of the screen where the screen is folded. Furthermore, when a single-tap gesture is made on one of the operation buttons displayed in the one half-region and subsequently the display 11 and the touch panel 12 are opened in a flat configuration, the controller 21 allows other subordinate operation buttons hierarchically lower than the specified operation button to be displayed in an empty space of the screen of the display 11.

The image forming apparatus 30 may have a structure including the display device 10. Alternatively, an image formation system including the display device 10 and the image forming apparatus 30 may be provided.

The structure and configuration of the above embodiment described with reference to FIGS. 1 to 5 are merely illustrative and are not intended to limit the present invention to these structure and configuration.

1. A display device comprising:
a display having flexibility to make the display foldable;
a touch panel provided on a screen of the display and having flexibility to make the touch panel foldable;
an openable and closable body that supports the display and the touch panel and is opened or folded together with the display and the touch panel when subjected to an opening or closing operation;
an opening/closing detecting device that detects an open state where the openable and closable body is opened and a closed state where the openable and closable body is folded; and
a controller that, upon detection of the open state by the opening/closing detecting device while allowing at least one icon or button to be displayed on the screen of the display in a state where the closed state is detected by the opening/closing detecting device, changes the icon or button in shape or size on the screen of the display.

2. The display device according to claim 1, wherein
while the closed state is detected by the opening/closing detecting device, the controller arranges and displays the icon or button in one of two half-regions of the screen of the display separated by a portion of the screen where the screen is folded during the closed state, and
when the open state is detected by the opening/closing detecting device, the controller elongates the shape of the icon or button having been arranged and displayed in the one half-region during the closed state in a direction perpendicular to the folded portion of the screen or increases the size of the icon or button, and arranges and displays the icon or button over the entire screen of the display.

3. The display device according to claim 1, wherein when the open state having been changed from the closed state is detected by the opening/closing detecting device, the controller identifies an icon or button having been operated through the touch panel on the screen of the display during the closed state, and allows information previously stored in association with the operated icon or button to be displayed in an empty space of the screen of the display being in the open state.

4. The display device according to claim 3, wherein the controller allows another icon or button previously stored in association with the operated icon or button to be displayed as the information in the empty space of the screen of the display being in the open state.

5. The display device according to claim 4, wherein the other icon or button is lower in level than the operated icon or button in a preset hierarchical structure of the icons or buttons.

6. The display device according to claim 4, wherein when the open state is detected by the opening/closing detecting device, the controller changes the shape or size of the icon or button on the screen of the display and changes arrangement of the icon or button to create the empty space.

7. The display device according to claim 2, wherein
when, after the closed state is detected by the opening/closing detecting device and before a certain period of time passes from a start time of arrangement and display of the icon or button in one of the two half-regions of the screen of the display separated by the folded portion of the screen during the closed state, a predetermined first tap gesture is made through the touch panel on an icon or button having been operated on the screen of the display during the closed state, the controller memorizes the icon or button on which the first tap gesture has been made, and
(i) thereafter when the open state having been changed from the closed state is detected by the opening/closing detecting device before the certain period of time passes, the controller allows information previously stored in association with the icon or button on which the first tap gesture has been made to be displayed in an empty space of the screen of the display being in the open state, or
(ii) thereafter when the open state having been changed from the closed state is not detected by the opening/closing detecting device before the certain period of time passes, the controller cancels the first tap gesture and avoids display of the information previously stored in association with the icon or button on which the first tap gesture has been made.

8. The display device according to claim 7, wherein when, before the certain period of time passes, a predetermined second tap gesture different from the first tap gesture is made through the touch panel on the icon or button having been operated on the screen of the display during the closed state, the controller executes processing previously associated with the icon or button on which the second tap gesture has been made.

9. An image forming apparatus comprising:
the display device according to claim 1; and
an image forming device capable of forming an image on a recording paper sheet.
